(19) United States
(12) Patent Application Publication
(10) Pub. No.: US 2026/0023531 A1
(43) Pub. Date: Jan. 22, 2026

(54) HIGH SPEED RANDOM NUMBER GENERATION

(71) Applicant: INTERNATIONAL BUSINESS MACHINES CORPORATION, Armonk, NY (US)

(72) Inventors: Rajat Rao, Bangalore (IN); Satyajit Bora, Golaghat (IN)

(21) Appl. No.: 18/778,660

(22) Filed: Jul. 19, 2024

(51) Int. Cl. G06F 7/58

(52) U.S. Cl. CPC G06F 7/588

(57) ABSTRACT

A plurality of first bitstreams can be received. Each of the plurality of first bitstreams can be received from a respective one of a plurality of oscillators. A plurality of samples can be generated by sampling each of the plurality of first bitstreams. A second bitstream can be generated by serially combining the plurality of samples. At least one random number can be generated based, at least in part, on the second bitstream. The at least one random number can be output to a processor.

### RESERVATION OF RIGHTS IN COPYRIGHTED MATERIAL

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The present invention relates to random number generators.

A random number generator generates a sequence of numbers and/or symbols that cannot be reasonably predicted better than by random chance. Random number generators commonly are used for statistical sampling, computer simulation, cryptography, completely randomized design, and other areas where producing an unpredictable result is desirable. True random number generators typically are hardware based, i.e., hardware random number generators. With true random number generators, each random number that is generated is, at least in part, a function of a current value of an attribute of a physical environment. In contrast, pseudorandom number generators, which are implemented using algorithms, produce numbers that are predetermined, though they may appear to be random.

### SUMMARY

A method includes receiving a plurality of first bitstreams, each of the plurality of first bitstreams received from a respective one of a plurality of oscillators. The method also can include generating a plurality of samples by sampling each of the plurality of first bitstreams. The method also can include generating a second bitstream by serially combining the plurality of samples. The method also can include generating at least one random number based, at least in part, on the second bitstream. The method also can include outputting the at least one random number to a processor.

A random number generator includes a plurality of oscillators. The random number generator also can include a hardware conditioner configured to receive a plurality of first bitstreams, each of the plurality of first bitstreams received from a respective one of the plurality of oscillators, generate a plurality of samples by sampling each of the plurality of first bitstreams, generate a second bitstream by serially combining the plurality of samples, and generate at least one random number based, at least in part, on the second bitstream. The random number generator can output the at least one random number to a processor.

A system includes a random number generator within, or communicatively linked to, a processor. The random number generator can include a plurality of oscillators. The random number generator also can include a hardware conditioner configured to receive a plurality of first bitstreams, each of the plurality of first bitstreams received from a respective one of the plurality of oscillators, generate a plurality of samples by sampling each of the plurality of first bitstreams, generate a second bitstream by serially combining the plurality of samples, and generate at least one random number based, at least in part, on the second bitstream. The random number generator can output the at least one random number to a processor.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 is a block diagram illustrating an example of a random number generator.

FIGS. 2A and 2B, together, are a block diagram illustrating example architecture for a hardware conditioner.

FIG. 3 is a flowchart illustrating an example of a method of performing high speed random number generation.

### DETAILED DESCRIPTION

This disclosure relates to random number generators. The arrangements described herein improve random number generation. Specifically, the present arrangements provide high speed random number generation while also improving random number bias. The present arrangements accomplish these improvements while providing high random number entropy.

According to an aspect of the invention, there is provided a method for generating at least one random number. The method includes receiving a plurality of first bitstreams. Each of the plurality of first bitstreams can be received from a respective one of a plurality of oscillators. The method also can include generating a plurality of samples by sampling each of the plurality of first bitstreams. The method also can include generating a second bitstream by serially combining the plurality of samples and generating at least one random number based, at least in part, on the second bitstream. The at least one random number can be output to a processor. In comparison to prior random number generation processes, the method increases randomness of random numbers that are generated.

In embodiments, the method also can include generating a third bitstream that is a bias conditioned version of the second bitstream. The third bitstream can be generated by applying a first whitening mask to the second bitstream. Applying the first whitening mask to the second bitstream bias conditions the third bitstream by spreading out, in the third bitstream, a distribution of bits within the second bitstream having a first value and bits within the second bitstream having a second value. In these arrangements, generating the at least one random number based, at least in part, on the second bitstream can include generating the at least one random number using the third bitstream. Applying the first whitening mask to bias condition the second bitstream improves the bias of random numbers that are generated without adversely affecting entropy of the random numbers. Moreover, applying the first whitening mask to the second bitstream can increase entropy of the bits contained in the third bitstream in comparison to the bits contained in the second bitstream. By increasing entropy of the bits contained in the third bitstream, even small sequences of bits in the third bitstream can have approximately equal numbers of zeros and ones. This can serve to make values generated using the random number safer from being decrypted by an unscrupulous party, thus increasing security of values generated using the random number.

In embodiments, the method also can include generating the first whitening mask by multiplexing a second whitening mask and a new mask. This can increase randomness of values contained in the first whitening mask, and thus serve to increase the randomness of the generated random number.

In embodiments, the method also can include generating the first whitening mask by multiplexing a second whitening mask, a third whitening mask and a new mask, wherein the third whitening mask is generated by performing a circular shift on the second whitening mask. This also can increase randomness of values contained in the first whitening mask, and thus serve to increase the randomness of the generated random number.

In embodiments, the method also can include generating a plurality of third bitstreams. Each of the plurality of third bitstreams can be a bias conditioned version of a respective one of the plurality of first bitstreams. The plurality of third bitstreams can be generated by applying a first whitening mask to each of the plurality first bitstreams. The applying the first whitening mask to each of the plurality of first bitstreams provides bias conditioning of the plurality of third bitstreams by spreading out, in the plurality of third bitstreams, a distribution of bits within the plurality of first bitstreams having a first value and bits within the plurality of first bitstreams having a second value. In these arrangements, the generating the plurality of samples by sampling each of the plurality of first bitstreams includes generating the plurality of samples by sampling each of the plurality of third bitstreams, which are bias conditioned versions of the plurality of first bitstreams. Applying the first whitening mask to each of the plurality of first bitstreams to bias condition the plurality of third bitstreams improves the bias of random numbers that are generated without adversely affecting entropy of the random numbers. Moreover, applying the first whitening mask to each of the plurality of third bitstreams can increase entropy of the bits contained in the third bitstream in comparison to the bits contained in the second bitstream. By increasing entropy of the bits contained in the third bitstream, even small sequences of bits in the third bitstream can have approximately equal numbers of zeros and ones. This can serve to make values generated using the random number safer from being decrypted by an unscrupulous party, thus increasing security of values generated using the random number.

In embodiments, the method also can include, responsive to determining that random number generation is to be paused, deactivating the plurality of oscillators. Deactivating the plurality of oscillators reduces energy consumption, thus increasing energy efficiency of a processing system implementing the present method.

The plurality of oscillators can be ring oscillators that are spatially separated, physically, from one another by a minimum threshold distance. The threshold distance can be at least 500 μm. Positioning the ring oscillators can serve to distribute power dissipation a processing system implementing the present method, thus reducing risk of too much power being concentrated in a particular area. This reduces risk of too high of a temperature rise occurring in a portion of a processing system implementing the present method. Moreover, positioning ring oscillators so that they are separated by the threshold distance can serve to reduce electromagnetic interference between the ring oscillators. This increases randomness of the first bitstreams.

According to an aspect of the invention, there is provided a random number generator. The random number generator includes a plurality of oscillators and a hardware conditioner configured to receive a plurality of first bitstreams. Each of the plurality of first bitstreams can be received from a respective one of the plurality of oscillators. The hardware conditioner can generate a plurality of samples by sampling each of the plurality of first bitstreams, and generate a second bitstream by serially combining the plurality of samples. The random number generator can generate at least one random number based, at least in part, on the second bitstream. The random number generator outputs the at least one random number to a processor. In comparison to prior random number generators, the random number generator outputs random numbers that have increased randomness.

In embodiments, the hardware conditioner can generate a third bitstream that is a bias conditioned version of the second bitstream. The hardware conditioner can generate the third bitstream by applying a first whitening mask to the second bitstream, the applying the first whitening mask to the second bitstream bias conditioning the third bitstream by spreading out, in the third bitstream, a distribution of bits within the second bitstream having a first value and bits within the second bitstream having a second value. In this arrangement, generating the at least one random number based, at least in part, on the second bitstream can include generating the at least one random number using the third bitstream. Applying the first whitening mask to bias condition the second bitstream improves the bias of random numbers that are generated without adversely affecting entropy of the random numbers. Moreover, applying the first whitening mask to the second bitstream can increase entropy of the bits contained in the third bitstream in comparison to the bits contained in the second bitstream. By increasing entropy of the bits contained in the third bitstream, even small sequences of bits in the third bitstream can have approximately equal numbers of zeros and ones. This can serve to make values generated using the random number safer from being decrypted by an unscrupulous party, thus increasing security of values generated using the random number.

In embodiments, the hardware conditioner can include a mask updater configured to generate the first whitening mask by multiplexing a second whitening mask and a new mask. This can increase randomness of values contained in the first whitening mask, and thus serve to increase the randomness of the generated random number.

In embodiments, the hardware conditioner can include a mask updater configured to generate the first whitening mask by multiplexing a second whitening mask, a third whitening mask and a new mask, wherein the third whitening mask is generated by performing a circular shift on the second whitening mask. This can increase randomness of values contained in the first whitening mask, and thus serve to increase the randomness of the generated random number.

In embodiments, the hardware generator can generate a plurality of third bitstreams. Each of the plurality of third bitstreams can be a bias conditioned version of a respective one of the plurality of first bitstreams. The plurality of third bitstreams can be generated by applying a first whitening mask to each of the plurality first bitstreams. The applying the first whitening mask to each of the plurality of first bitstreams provides bias conditioning of the plurality of third bitstreams by spreading out, in the plurality of third bitstreams, a distribution of bits within the plurality of first bitstreams having a first value and bits within the plurality of first bitstreams having a second value. In these arrangements, the hardware conditioner generates the plurality of samples by sampling each of the plurality of third bitstreams, which are bias conditioned versions of the plurality of first bitstreams. Applying the first whitening mask to each of the plurality of first bitstreams to bias condition the plurality of third bitstreams improves the bias of random numbers that are generated without adversely affecting entropy of the random numbers. Moreover, applying the first whitening mask to each of the plurality of first bitstreams can increase entropy of the bits contained in the third bitstream in comparison to the bits contained in the second bitstream. By increasing entropy of the bits contained in the third bitstream, even small sequences of bits in the third bitstream can have approximately equal numbers of zeros and ones. This can serve to make values generated using the random number safer from being decrypted by an unscrupulous party, thus increasing security of values generated using the random number.

In embodiments, the random number generator can be configured to, responsive to determining that random number generation is to be paused, deactivate the plurality of oscillators. Deactivating the plurality of oscillators reduces energy consumption, thus increasing energy efficiency of a the random number generator.

In embodiments, the plurality of oscillators can be ring oscillators that are spatially separated, physically, from one another by a minimum threshold distance. The threshold distance can be at least 500 μm. Positioning the ring oscillators can serve to distribute power dissipation a processing system implementing the present method, thus reducing risk of too much power being concentrated in a particular area. This reduces risk of too high of a temperature rise occurring in a portion of a processing system implementing the present method. Moreover, positioning ring oscillators so that they are separated by the threshold distance can serve to reduce electromagnetic interference between the ring oscillators. This increases randomness of the first bitstreams.

According to an aspect of the invention, there is provided a system that includes a random number generator within, or communicatively linked to, a processor. The random number generator can include a plurality of oscillators and a hardware conditioner. The hardware conditioner can be configured to receive a plurality of first bitstreams. Each of the plurality of first bitstreams can be received from a respective one of the plurality of oscillators. The hardware conditioner can generate a plurality of samples by sampling each of the plurality of first bitstreams. The hardware conditioner can generate a second bitstream by serially combining the plurality of samples. The random number generator can generate at least one random number based, at least in part, on the second bitstream. The random number generator outputs the at least one random number to the processor. In comparison to prior random number generators, the random number generator outputs random numbers that have increased randomness.

In embodiments, the hardware conditioner can generate a third bitstream that is a bias conditioned version of the second bitstream. The hardware conditioner can generate the third bitstream by applying a first whitening mask to the second bitstream, the applying the first whitening mask to the second bitstream bias conditioning the third bitstream by spreading out, in the third bitstream, a distribution of bits within the second bitstream having a first value and bits within the second bitstream having a second value. In this arrangement, generating the at least one random number based, at least in part, on the second bitstream can include generating the at least one random number using the third bitstream. Applying the first whitening mask to bias condition the second bitstream improves the bias of random numbers that are generated without adversely affecting entropy of the random numbers. Moreover, applying the first whitening mask to the second bitstream can increase entropy of the bits contained in the third bitstream in comparison to the bits contained in the second bitstream. By increasing entropy of the bits contained in the third bitstream, even small sequences of bits in the third bitstream can have approximately equal numbers of zeros and ones. This can serve to make values generated using the random number safer from being decrypted by an unscrupulous party, thus increasing security of values generated using the random number.

In embodiments, the hardware conditioner can include a mask updater configured to generate the first whitening mask by multiplexing a second whitening mask and a new mask. This can increase randomness of values contained in the first whitening mask, and thus serve to increase the randomness of the generated random number.

In embodiments, the hardware conditioner can include a mask updater configured to generate the first whitening mask by multiplexing a second whitening mask, a third whitening mask and a new mask, wherein the third whitening mask is generated by performing a circular shift on the second whitening mask. This can increase randomness of values contained in the first whitening mask, and thus serve to increase the randomness of the generated random number.

In embodiments, the hardware generator can generate a plurality of third bitstreams. Each of the plurality of third bitstreams can be a bias conditioned version of a respective one of the plurality of first bitstreams. The plurality of third bitstreams can be generated by applying a first whitening mask to each of the plurality first bitstreams. The applying the first whitening mask to each of the plurality of first bitstreams provides bias conditioning of the plurality of third bitstreams by spreading out, in the plurality of third bitstreams, a distribution of bits within the plurality of first bitstreams having a first value and bits within the plurality of first bitstreams having a second value. In these arrangements, the hardware conditioner generates the plurality of samples by sampling each of the plurality of third bitstreams, which are bias conditioned versions of the plurality of first bitstreams. Applying the first whitening mask to each of the plurality of first bitstreams to bias condition the plurality of third bitstreams improves the bias of random numbers that are generated without adversely affecting entropy of the random numbers. Moreover, applying the first whitening mask to each of the plurality of first bitstreams can increase entropy of the bits contained in the third bitstream in comparison to the bits contained in the second bitstream. By increasing entropy of the bits contained in the third bitstream, even small sequences of bits in the third bitstream can have approximately equal numbers of zeros and ones. This can serve to make values generated using the random number safer from being decrypted by an unscrupulous party, thus increasing security of values generated using the random number.

In embodiments, the random number generator can be configured to, responsive to determining that random number generation is to be paused, deactivate the plurality of oscillators. Deactivating the plurality of oscillators reduces energy consumption of the system, thus increasing energy efficiency of the random number generator.

In one or more arrangements, the hardware conditioner can include both the mask updater, which can be configured to generate the first whitening mask by multiplexing a second whitening mask and a new mask, in combination with the mask updater, which can be configured to generate the first whitening mask by multiplexing a second whitening mask, a third whitening mask and a new mask, wherein the third whitening mask is generated by performing a circular shift on the second whitening mask.

Various aspects of the present disclosure are described by narrative text, flowcharts, block diagrams of computer systems and/or block diagrams of the machine logic. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

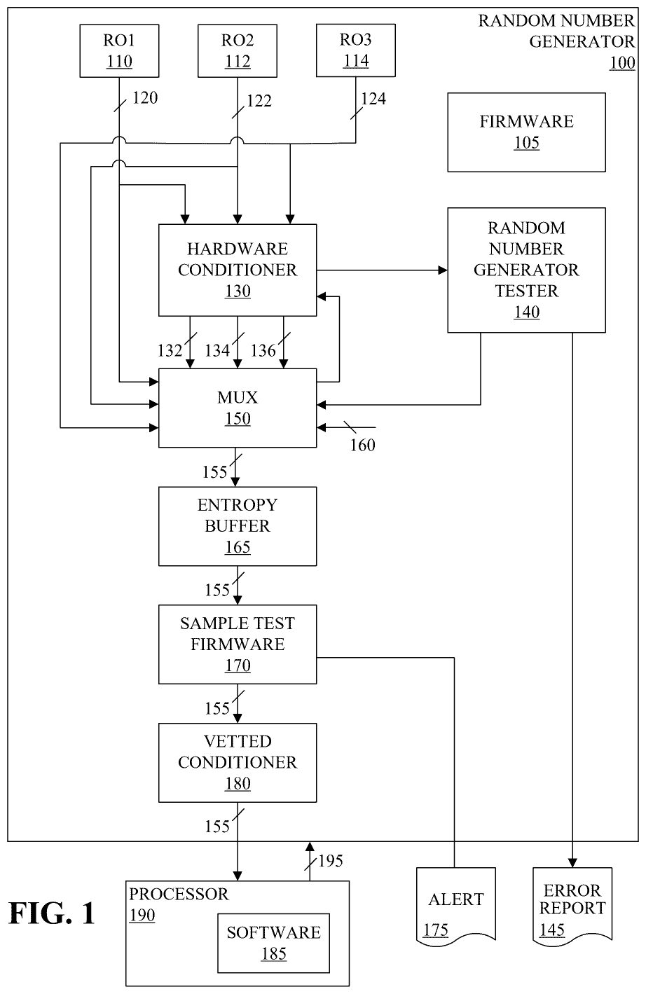

FIG. 1 is a block diagram illustrating an example of a random number generator 100. Random number generator 100 can be implemented as a hardware based true random number generator (TRNG), for example in a processor or co-processor. In illustration, random number generator 100 can be implemented in co-processor blocks within a processor, or implemented in a co-processor communicatively linked to a processor. In addition to being implemented using hardware, random number generator 100 can utilize firmware 105 and/or software. Firmware 105 and/or software can implement various decision processes to make decisions for random number generator 100, monitor temperatures of oscillators 110, 112, 114, communicate with a processor, etc. Nonetheless, being implemented as a TRNG, random number generator 100 can produce truly random numbers and can operate more efficiently than other types of random number generators (e.g., pseudorandom number generators) that are primarily implemented as software algorithms executed by a processor.

Random number generator 100 can include a plurality of oscillators, for example oscillator (O1) 110, oscillator (O2) 112 and oscillator (O3) 114. In one or more arrangements, oscillators 110, 112, 114 can be ring oscillators. Each oscillator 110, 112, 114 can generate and output a respective bitstream 120, 122, 124. Each bitstream 120, 122, 124 can be a serial bitstream oscillating between two voltage levels, wherein one voltage level represents zero (0), or false, and the other voltage level represents one (1), or true.

Oscillators 110, 112, 114 can be positioned within random number generator 100 in a manner in which they are spatially separated, physically, from one another by a minimum threshold distance. The minimum threshold distance can be, for example, 500 μm, 600 μm, 700 μm, 800 μm, 900 μm, 1.0 mm, 1.1 mm, 1.2 mm, 1.3 mm, 1.4 mm or 1.5 mm. Positioning oscillators 110, 112, 114 in this manner, for instance if oscillators 110, 112, 114 are ring oscillators, can serve to distribute power dissipation in random number generator 100, thus reducing risk of too much power being concentrated in a particular area of random number generator 100. This reduces risk of too high of a temperature rise occurring in a portion of random number generator 100. Moreover, positioning oscillators 110, 112, 114 so that they are separated by the threshold distance can serve to reduce electromagnetic interference between oscillators 110, 112, 114, thereby increasing randomness of bitstreams 120, 122, 124. In this regard, too much electromagnetic interference between oscillators 110, 112, 114 can cause a change to oscillations between voltage levels, and thus cause errors in the bitstreams 120, 122, 124 that reduce randomness of bits output in bitstreams 120, 122, 124.

Random number generator 100 also can include a hardware conditioner 130 that receives a respective bitstream 120, 122, 124 from each oscillator 110, 112, 114. For example, hardware conditioner 130 can serially interleave sampling of bitstreams 120, 122, 124 and, based on the sampling, generate at least one bitstream 132 that is bias conditioned. In one or more arrangements, hardware conditioner 130 can generate a plurality of bitstreams 132, 134, 136 that are bias conditioned.

In illustration, hardware conditioner 130 can receive 64-bits from bitstream 120, then receive 64-bits from bitstream 122, then receive 64-bits from bitstream 124, then receive 64-bits from bitstream 120 or bitstream 122, and so on. In this regard, hardware conditioner 130 can randomly select which bitstream 120, 122, 124 to sample for any given sample. Nonetheless, the present arrangements are not limited in this regard. For instance, hardware conditioner 130 can serially sample respective bitstreams 120, 122, 124 in a specific order (e.g., in a round robin manner), or serially sample respective bitstreams 120, 122, 124 in any other suitable manner. Using the samples from bitstreams 120, 122, 124, hardware conditioner 130 can generate bitstream 132. In another example, hardware conditioner 130 can generate a plurality of bitstreams 132, 134, 136 for samples taken from respective bitstreams 120, 122, 124, respectively.

To bias condition bitstreams 132, 134, 136 hardware conditioner 130 can spread out the distribution of ones and zeros sampled from bitstreams 120, 122, 124 and achieve approximately an equal number of ones and zeros. In illustration, hardware conditioner 130 can ensure that a number of ones in each bitstream 132, 134, 136 does not deviate from a number of zeros in that bitstream 132, 134, 136 by more than a threshold value (e.g., 0.1%, 0.5%, 1%, 2%, 3%, 4% or 5%). In general, random numbers generated from a bitstream 132, 134, 136 having approximately an equal number of ones and zeros are considered to be more secure in comparison to random numbers generated from a bitstream having a larger difference between the numbers of ones and zeros.

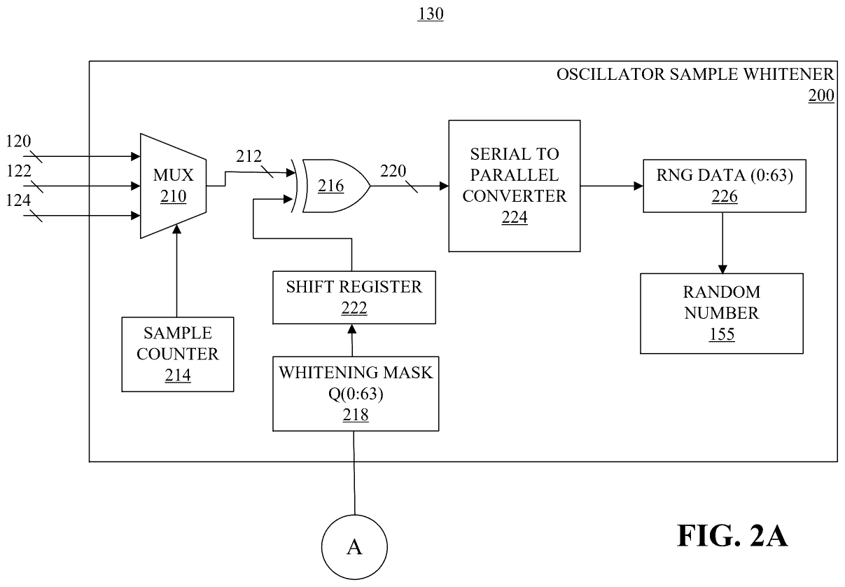

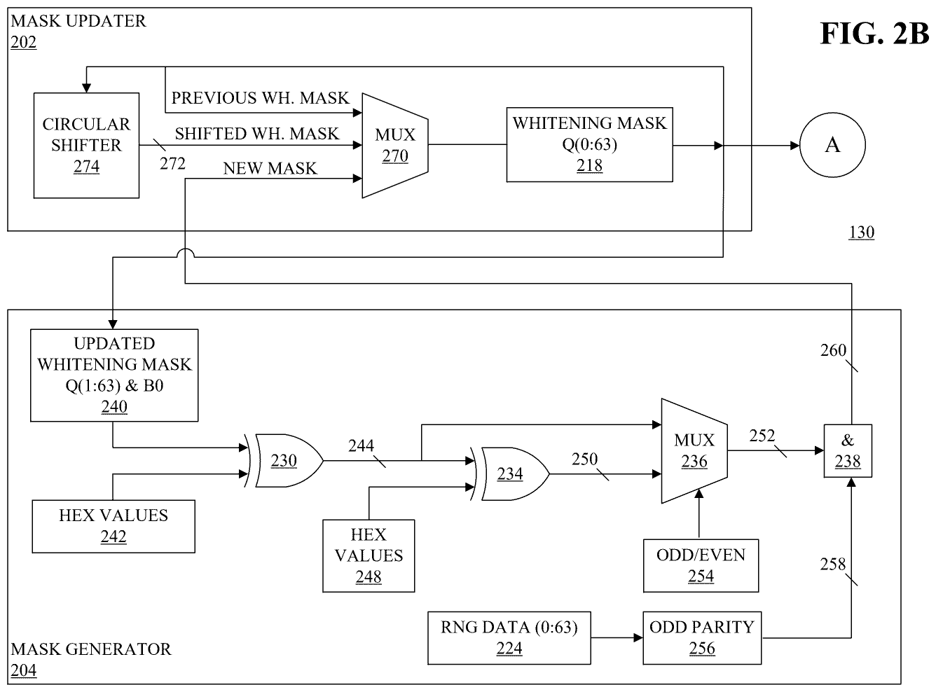

As will be described in further detail with respect to FIGS. 2A and 2B, hardware conditioner 130 can utilize one or more whitening masks. Whitening masks can be used to bias condition bitstream 132, or bitstreams 132, 134, 136, by increasing entropy of zeros and ones contained therein (e.g., spreading zero and one bit values). By increasing entropy of bitstream 132, or bitstreams 132, 134, 136, even small sequences of bits in a bitstream 132, 134, 136 can have approximately equal numbers of zeros and ones. In illustration, any sequence of 16-bits within bitstream 132 can have approximately equal numbers of zeros and ones (e.g., eight zeros and eight ones, seven zeros and nine ones, or nine zeros and seven ones), though the zeros and ones are randomly distributed in the sequence.

Random number generator 100 also can include a random number generator tester 140. In one or more arrangements, random number generator tester 140 can be implemented as firmware residing in random number generator 100. Random number generator tester 140 can test bitstreams 120, 122, 124 to determine whether zeros and ones in bitstreams 120, 122, 124 are properly randomized. In illustration, assume that hardware conditioner 130 is sampling 64-bits from each of bitstreams 120, 122, 124. Random number generator tester 140 can determine whether each 64-bit sample is properly randomized. Since each 64-bit sample is generated by a particular oscillator 110, 112, 114, random number generator tester 140 can test the output of each oscillator 110, 112, 114. Responsive to random number generator tester 140 determining that a 64-bit sample is not properly randomized, random number generator 100 can implement a pre-determined action. For example, random number generator 100 (e.g., at the behest of firmware 105) can deactivate the oscillator 110, 112, 114 that generated the bitstream 120, 122, 124 from which the 64-bit sample was acquired. In another example, random number generator 100 can ignore the bitstream 120, 122, 124, from which that 64-bit sample was acquired, for at least a threshold period of time. Random number generator tester 140 can test subsequent samples acquired from that bitstream 120, 122, 124. Responsive to a threshold number of samples (e.g., 3, 5, 10, etc.) being determined to not be properly randomized, random number generator 100 can deactivate (e.g., at the behest of firmware 105) the oscillator 110, 112, 114 that generated the bitstream 120, 122, 124 from which the improperly randomized samples were taken.

Further, random number generator tester 140 can output an error report 145 indicating the oscillator 110, 112, 114 that generated the bitstream 120, 122, 124 from which the sample(s), which was/were not properly randomized, was/were acquired. Error report 145 also can indicate one or more time stamps indicating when the improperly randomized sample(s) was/were received by hardware conditioner 130, a measured temperature of the oscillator 110, 112, 114 when the improperly randomized samples were detected, etc. Random number generator 100 can communicate error report 145 to a processor in which random number generator 100 is integrated or to which random number generator 100 is communicatively linked

In one or more arrangements, random number generator tester 140 can periodically test samples of bitstreams 120, 122, 124, for example every 5 ms, every 10 ms, every 15 ms, every 20 ms, every 25 ms, or so on. In one or more arrangements, random number generator tester 140 can test samples of bitstreams 120, 122, 124 at different threshold temperatures. For instance, random number generator tester 140 can perform testing responsive to one or more of oscillators 110, 112, 114 reaching a temperature of 40° C., again perform testing responsive to one or more of oscillators 110, 112, 114 reaching a temperature of 45° C., again perform testing responsive to one or more of oscillators 110, 112, 114 reaching a temperature of 50° C., and so on. In this regard, random number generator 100 can include one or more temperature sensors (not shown) configured to measure the temperature of one or more of oscillators 110, 112, 114.

Random number generator 100 also can include a multiplexer 150. Multiplexer 150 can generate random numbers 155, either from one or more bitstreams 132, 134, 136 output by hardware conditioner 130 or from bitstreams 120, 122, 124. Each random number 155 can have a desired number of bits. The desired number of bits can be, for example, in a range of 500 bits to 4000 bits, though the present arrangements are not limited in this regard.

Multiplexer 150 can generate random numbers 155 according to one or more encoding bits 160 set for random number generator 100. Encoding bits 160 can be set by a processor in which random number generator 100 is integrated or to which random number generator 100 is communicatively linked. Table 1 depicts example values of encoding bits 160 and example operations that multiplexer 150 can perform to generate random numbers 155 responsive to respective encoding bits 160 being set.

TABLE 1

| Value | Operation |
|---|---|
| 0 | Sample from bitstreams of all oscillators and apply hardware |
| | conditioning |
| 1 | Sample from a bitstream of a first oscillator |
| 2 | Sample from a bitstream of a second oscillator |
| 3 | Sample from a bitstream of a third oscillator |
| 4 | Force sample to be all zeros |
| 5 | Force sample to be all ones |
| 6 | Reserved, treated as if all zeros is specified |
| 7 | Sample from bitstreams of all oscillators, exclusive ORed (XOR) |
| | together, and apply hardware conditioning |

In this example, if encoding bits 160 are set to “1,” “2,” “3,” multiplexer 150 can receive bitstreams 120, 122, 124 from oscillators 110, 112, 114, and generate random numbers 155 from bitstreams 120, 122, 124, bypassing hardware conditioner 130. Accordingly, conditioning of the samples need not be performed if encoding bits 160 are set to “1,” “2” or “3.”

In illustration, if encoding bits 160 are set to “1,” multiplexer 150 can generate random numbers 155 from bitstream 120. If encoding bits 160 are set to “2,” multiplexer 150 can generate random numbers 155 from bitstream 122. If encoding bits 160 are set to “3,” multiplexer 150 can generate random numbers 155 from bitstream 124.

If encoding bits 160 are set to “0,” “4,” “5” “6” or “7,” hardware conditioner 130 can be implemented to condition the samples as described herein. In this regard, multiplexer 150 can generate random numbers 155 from biased conditioned bitstream(s) 132, 134, 136 output by hardware conditioner 130.

In illustration, if encoding bits 160 are set to “0,” multiplexer 150 can set hardware conditioner 130 to condition bitstreams 120, 122, 124 independently. Accordingly, bitstream 132 can be generated by conditioning bitstream 120, bitstream 134 can be generated by conditioning bitstream 122, and bitstream 136 can be generated by conditioning bitstream 124. Multiplexer 150 can generate random numbers by multiplexing bitstreams 132, 134, 136.

If encoding bits 160 are set to “7,” multiplexer 150 can set hardware conditioner 130 to combine bitstreams 120, 122, 124 using an exclusive OR (XOR) gate and one or more shift registers (not shown), and condition the combined bitstream output by the XOR gate. Accordingly, hardware conditioner 130 need only output a single bitstream, e.g., bitstream 132, to multiplexer 150. Multiplexer 150 can generate random numbers from that bitstream 132.

If encoding bits 160 are set to “4” or “6,” multiplexer 150 can set hardware conditioner 130 to output all zeros as bitstream 132. Accordingly, random numbers 155 generated by multiplexer 150 will include bits only having a value of zero. If encoding bits 160 are set to “5,” random numbers 155 generated by multiplexer 150 will include bits only having a value of one. Encoding bits 160 can be set to “4,” “5” or “6” for testing purposes.

Random number generator 100 also can include an entropy buffer 165. Entropy buffer 165 can buffer the bits of random numbers 155 output by multiplexer 150. Entropy buffer 165 can compensate for differences in the rate at which multiplexer 150 generates the bits of random numbers 155. Entropy buffer 165 can be, for example, a 256 byte data buffer. In one or more arrangements, responsive to entropy buffer 165 becoming full, random number generator 100 (e.g., at the behest of firmware 105) can deactivate oscillators 110, 112, 114, which can reduce the amount of power used by random number generator 100, thereby increasing efficiency of random number generator 100.

Random number generator 100 also can include sample test firmware 170. Sample test firmware 170 can perform testing of random numbers 155 generated by multiplexer 150. In illustration, sample test firmware 170 can test random numbers 155 in accordance with National Institute of Standards and Technology (NIST) Special Publication (SP) 800-90B. Responsive to a random number 155 failing a test, sample test firmware 170 can generate an alert 175. Random number generator 100 can communicate alert 175 to a processor 190 in which random number generator 100 is integrated or to which random number generator 100 is communicatively linked. Further, responsive to a random number 155 failing the test, sample test firmware 170 can discard that random number 155 and continue testing subsequently generated random numbers 155. If a threshold number of random numbers 155 fail the test, for example a threshold number of alerts 175 are generated withing a threshold period of time, processor 190, in which random number generator 100 is integrated or to which random number generator 100 is communicatively linked, can deactivate random number generator 100 and activate a different random number generator. Processor can deactivate random number generator 100, for example, by communicating an indicator 195 to random number generator 100. Firmware 105 can process indicator 195 to deactivate random number generator 100.

Random number generator 100 also can include a vetted conditioner 180. Vetted conditioner 180 can compress random numbers 155 and increase the entropy of random numbers 155 on a per byte basis. Vetted conditioner 180 can be implemented using a cryptographic library, for example Hash-Based Message Authentication Code (HMAC) or Advanced Encryption Standard (AES) cipher block chaining message authentication code (CBC-MAC).

Random number generator 100 can output one or more random numbers 155 to software 185 (e.g., an application) that uses at least one random number. Specifically, a processor 190 executing the software 185 can receive the random number(s) 155 output by random number generator 100. Processor 190 can be a processor comprising random number generator 100, or a processor to which random number generator 100 is communicatively linked. Software 185 can perform statistical sampling, computer simulation, cryptography, completely randomized design, or any other computing functionality that uses random numbers.

In one or more arrangements, random number generator 100 can receive from processor 190 one or more indicators indicating that additional random numbers 155 are to be generated and/or indicating that random number generation can be paused. Responsive to random number generator 100 receiving an indicator 195 indicating random number generation is to be paused, random number generator 100 (e.g., firmware 105) can deactivate oscillators 110, 112, 114. Responsive to random number generator 100 receiving an indicator 195 additional random numbers 155 are to be generated, if one or more oscillators 110, 112, 114 are deactivated, random number generator 100 (e.g., firmware 105) can activate oscillators 110, 112, 114 that are deactivated. Deactivating oscillators 110, 112, 114 when random numbers are not needed can reduce power usage by random number generator 100.

FIGS. 2A and 2B, together, are a block diagram illustrating example architecture for a hardware conditioner 130. Hardware conditioner 130 can include an oscillator sample whitener 200 (FIG. 2A), a mask updater 202 (FIG. 2B) and a mask generator 204 (FIG. 2B).

Referring to FIG. 2A, oscillator sample whitener 200 can include a multiplexer 210. Multiplexer 210 can receive bitstreams 120, 122, 124 as inputs. If encoding bits 160 are set to a value of “0,” multiplexer 210 can sample multiplex bitstreams 120, 122, 124 into a bitstream 220. In illustration, multiplexer 210 can sample bitstreams 120, 122, 124 to generate a plurality of samples. Multiplexer 210 can generate a bitstream 220 by serially combining those samples, for example by interleaving the samples. A sample counter 214 communicatively linked to multiplexer 210 can determine the sample size.

If encoding bits 160 are set to a value of “7,” multiplexer 210 can generate bitstream 212 by communicating bitstreams 120, 122, 124 to an XOR gate, which may be a component of multiplexer 210. In this regard, bitstream 212 can be the output of the XOR gate receiving bitstreams 120, 122, 124 as respective inputs. By way of example, if there are three oscillators 110, 112, 114, the XOR gate can be a 3-input XOR gate. The output Q of the 3-input XOR gate, per clock cycle, can be as follows:

$$Q = A ⊕ B ⊕ C$$

where A, B and C are bits from bitstreams 120, 122, 124 received by the XOR gate at the same clock cycle.

Multiplexer 210 can output bitstream 212 to an XOR gate 216. Using XOR gate 216, oscillator sample whitener 200 can apply a whitening mask 218 to bitstream 212 to generate a bitstream 220 that is a bias conditioned version of bitstream 212. Applying whitening mask 218 to bitstream 212 can bias condition bitstream 220 by spreading out a distribution of bits within bitstream 212 having a value of zero and bits within bitstream 212 having a value of one. The spreading out of the bits increases entropy of the bits in bitstream 220 in comparison to the bits in bitstream 212.

XOR gate 216 can be a 2-input XOR gate configured to receive bitstream 212 on one input and receive whitening mask 218 on another input. In illustration, if whitening is to be performed on 64-bit sequences, whitening mask 218 can include 64-bits (e.g., bits 0:63). XOR gate 216 can output bitstream 220. The output X of XOR gate 216, per clock cycle, can be as follows:

$$X = A ⊕ B$$

where A is a bit of bitstream 212 and B is a bit of whitening mask 218, both received by XOR gate 216 at the same clock cycle. One or more shift registers 222 can be used to select the bits for each clock cycle.

In one or more arrangements, after a number of clock cycles equal to the number of bits in whitening mask 218, a shift register (not shown) can shift to a first bit of whitening mask 218 so as to continue using that whitening mask 218 to generate bitstream 220 until a random number 155 is generated by oscillator sample whitener 200. After a random number 155 is generated, oscillator sample whitener 200 can use a new whitening mask 218 to generate bitstream 220 until a next random number 155, and so on.

In one or more arrangements, after a number of clock cycles equal to the number of bits in whitening mask 218, oscillator sample whitener 200 can use a new whitening mask 218 to generate bitstream 220. For example, if whitening mask 218 is 64-bit, after 64 clock cycles a new whitening mask 218 can be received from mask updater 202. The new whitening mask 218 can be generated by mask updater 202 and mask generator 204, as will be described.

A serial to parallel converter 224 can receive bitstream 220, which is serial, and convert bitstream 220 to parallel values. In illustration, each 64-bits of bitstream 220 generated can be converted to a 64-bit value as random number generator data 226. Oscillator sample whitener 200 can accumulate random number generator data 226 until there are enough random number generator data 226 available to combine in a sequence to generate a random number 155. By way of example, if random number 155 is a 512-bit value and each random number generator data 226 is a 64-bit value, oscillator sample whitener 200 can combine eight of the 64-bit random number generator values to generate a random number 155.

Referring to FIG. 2B, mask generator can include an XOR gate 230, an XOR gate 234, a multiplexer 236 and a concatenator 238. Mask generator 204 can receive a previously generated whitening mask 218 from mask updater 202. Mask generator 204 can generate an updated whitening mask 240 by replacing a bit within whitening mask 218 with an arbitrarily selected bit. For example, mask generator 204 can remove a last bit from whitening mask 218, shift the remaining bits right by one bit, and add a new first bit that is arbitrarily selected.

XOR gate 230 can receive updated whitening mask 240 as one input, receive hexadecimal values 242 as another input, and output a bitstring 244. Hexadecimal values 242 can be, for example, O×AAAAA . . . AA. The output X of XOR gate 230, per clock cycle, can be as follows:

$$X = A ⊕ B$$

where A is a bit of updated whitening mask 240 and B is a bit of hexadecimal values 242, both received by XOR gate 230 at the same clock cycle. One or more shift registers (not shown) can be used to select the bits for each clock cycle. Bitstring 244 can comprise 63-bit values (e.g., bits 0:62). In illustration, XOR gate 230 can be configured to not output a least significant bit resulting from the exclusive OR operations performed by XOR gate 230. In this regard, the output of XOR gate 230 can be sinkless.

XOR gate 234 can receive bitstring 244 as an input, receive hexadecimal values 248 as another input, and output a bitstring 250. Hexadecimal values 242 can be, for example, 0×FFFFF . . . FF. The output X of XOR gate 234, per clock cycle, can be as follows:

$$X = A ⊕ B$$

where A is a bit of bitstring 244 and B is a bit of hexadecimal values 248, both received by XOR gate 234 at the same clock cycle. One or more shift registers (not shown) can be used to select the bits for each clock cycle. Bitstring 250 can comprise 63-bit values (e.g., bits 0:62). In the case that hexadecimal values 242 arc O×FFFFF . . . FF, bitstring 250 can be a version of bitstring 244 in which the value of each bit is reversed (i.e., zeros are changed to ones and ones are changed to zeros). Accordingly, bitstring 250 can be referred to as a flip mask.

Multiplexer 236 can receive bitstring 244 as an input, receive bitstring 250 as another input, and output a bitstring 252. Multiplexer 236 also can receive an odd/even indicator 254 for each clock cycle. Multiplexer 236 can multiplex bitstrings 244, 250, according to odd/even indicator 254, to generate bitstring 252. Bitstring 252 can comprise 63-bit values (e.g., bits 0:62). In illustration, if odd/even indicator 254 is an odd value (e.g., 1), multiplexer can output bitstream 244 as bitstream 252. If odd/even indicator 254 is an even value (e.g., 0), multiplexer can output bitstream 250 as bitstream 252. The value of odd/even indicator 254 can be changed between odd and even

Mask generator 204 can receive random number generator data 226 from oscillator sample whitener 200. If random number generator data 226 includes an even number of bits having a value of one, odd parity 256 can output a bit 258 having a value of zero. If random number generator data 226 includes an odd number of bits having a value of one, odd parity 256 can output a bit 258 having a value of one.

Concatenator 238 can receive bitstring 252 as an input and receive bit 258 as another input. Concatenator 238 can add bit 258 to bitstring 252 to generate a new mask 260. In illustration, concatenator 238 can add bit 258 to bitstring 252 as a least significant bit (e.g., bit 63), thereby creating new mask 260 as a 64-bitstring (e.g., bits 0:63). In this regard, the least significant bit of new mask 260 can be determined based on the parity of the previously generated random number 155.

Mask updater 202 can include a multiplexer 270. Multiplexer 270 can receive new mask 260 as an input, and receive whitening mask 218 as another input. From the perspective of multiplexer 270 input, whitening mask 218 can be considered a previous whitening mask. Multiplexer 270 also can receive a shifted whitening mask 272 from a circular shifter 274. Circular shifter 274 can perform a right circular shift on whitening mask 218 to generate shifted whitening mask 272. Multiplexer 270 can multiplex previous whitening mask 218, shifted whitening mask 275 and new mask 260 to generate a new whitening mask 218. In this regard, multiplexer 270 can generate a new whitening mask 218 for every new set of 64-bits received on each of its inputs.

In one or more arrangements, multiplexer 270 can serially sample previous whitening mask 218, shifted whitening mask 272 and new mask 260 in a specific order (e.g., in a round robin manner), or serially sample bitstreams 120, 122, 124 in any other suitable manner. In illustration, multiplexer can sample a number of bits from previous whitening mask 218, then sample a number of bits from shifted whitening mask 272, then sample a number of bits from new mask 260. Multiplexer 270 can serially output the sampled bits for addition to a new whitening mask 218 until the new whitening mask 218 includes values for the number of bits specified for the whitening mask 218. The number of bits sampled from previous whitening mask 218, shifted whitening mask 272 and mew mask 260 can be pre-determined or randomly chosen. The number of bits can be at least 1, but not greater than the number of bits contained in whitening mask 218. In illustration, if whitening mask 218 is 64-bit, the number bits in each sample can be from 1 to 64.

At this point it should be noted that on initial startup of random number generator 100, or resumption of random number generator 100 from a paused state, random number generator 100 can be configured to arbitrarily generate an initial whitening mask 218 to begin random number generation, or random number generator 100 can be configured to select an initial whitening mask 218 from one or more whitening masks that are stored for use on startup of random number generator 100. Random number generator 100 can discard one or more initial random numbers 155 that are generated. The number of initial random numbers 155 that are discarded can be a threshold number of random numbers 155 or a number of random numbers 155 generated within a threshold period of time after startup of random number generator 100.

The following pseudocode is useful for understanding whitening mask generation performed by mask updater 202 and mask generator 204:

```
for ( i=0; i<NUM_RN; i++ )
{
  //Left shift, then invert every other bit
  baseMask = (baseMask << 1) \hat{ } 0xAA...A;
  //Use parity of previous random number for last bit of baseMask
  //Every other whitening iteration, use inverted parity
  baseMask[63] = parity( whitenedRN[i−1] ) \hat{ } (i%2);
  //Determine appliedMask
  appliedMask = baseMask;
  if(i%2) appliedMask = flip( appliedMask );
  //Whiten
  whitenedRN[i] = unwhitenedRN[i] \hat{ } appliedMask;
}
```

The following pseudocode is a simplified version of the above pseudocode:

```
for ( i=0; i<NUM_RN; i++ )
{
    baseMask = (baseMask << 1) \hat{ } 0xAA...A;
  appliedMask = baseMask;
  if(i%2) appliedMask = flip( appliedMask );
  appliedMask[63] = parity(whitenedRN[i−1] ) ;
  whitenedRN[i] = unwhitenedRN[i] \hat{ } appliedMask;
}
```

The following pseudocode is a version of the above pseudocode with renaming:

| for ( i=0; i<NUM_RN; i++ ) | |
|---|---|
| { | |
| mask1 = (whitening_mask_q << 1) \hat{ } 0xAA...A; | |
| flip_mask1 = mask1 \hat{ } 0xFF...F | |
| if(i%2) New Mask = flip_mask1; | // odd |
| else New Mask = mask1; | // even |

```
  New Mask[63] = parity(rng_ib_wrdata[i−1]);
  whitenedRN[i] = unwhitenedRN[i] \hat{ } appliedMask;
}
```

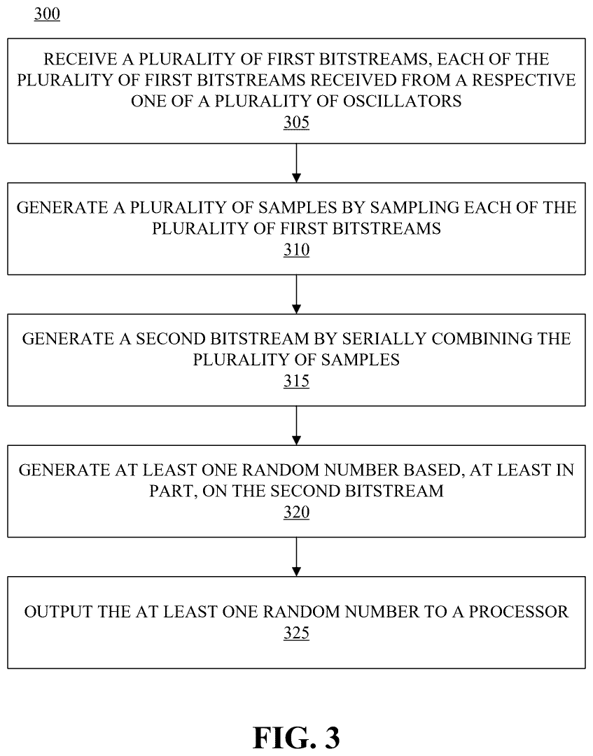

FIG. 3 is a flowchart illustrating an example of a method 300 of performing high speed random number generation. Method 300 can be implemented by random number generator 100.

At step 305, random number generator 100 can receive a plurality of first bitstreams, each of the plurality of first bitstreams received from a respective one of a plurality of oscillators.

At step 310, random number generator 100 can generate a plurality of samples by sampling each of the plurality of first bitstreams.

At step 315, random number generator 100 can generate a second bitstream by serially combining the plurality of samples.

At step 320, random number generator 100 can generate at least one random number based, at least in part, on the second bitstream.

At step 325, random number generator 100 can output the at least one random number to a processor.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Several definitions that apply throughout this document will now be presented.

As defined herein, the term “entropy” means an amount of randomness in a digital bit sequence (e.g., bit stream or bitstring). Highest entropy is achieved when there are an equal number of zeros and ones in a digital bit sequence, as well as an equal number of zeros and ones in arbitrary segments of the digital bit sequence. In illustration, a bitstream sample (e.g., a 64-bit sample) is considered to have high entropy if that bitstream sample has an equal number of zeros and ones, and an arbitrary segment of the that bitstream sample (e.g., a 16-bit segment within the sample) also has an equal number of zeros and ones.

As defined herein, the term “random number bias” means a tendency of a digital bit sequence (e.g., bitstream or bitstring) towards having random bit values within the digital bit sequence.

As defined herein, the term “bias conditioning” means to implement at least one action to increase randomness of bit values in a digital bit sequence (e.g., bitstream or bitstring).

As defined herein, the term “whitening mask” means a bitstring configured to be applied to a digital bit sequence (e.g., bitstream or bitstring) to increase entropy of bits in the digital bit sequence.

As defined herein, the term “bitstring” means a sequence of bits comprising zeros and ones.

As defined herein, the term “bitstream” means a streaming sequence bits comprising zeros and ones.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “output” means storing in memory elements, writing to display or other peripheral output device, sending or transmitting to another system, exporting, or similar operations.

What is claimed is:

1. A method, comprising:
receiving a plurality of first bitstreams, each of the plurality of first bitstreams received from a respective one of a plurality of oscillators;
generating a plurality of samples by sampling each of the plurality of first bitstreams;
generating a second bitstream by serially combining the plurality of samples;
generating at least one random number based, at least in part, on the second bitstream; and
outputting the at least one random number to a processor.

2. The method of claim 1, further comprising
generating a third bitstream that is a bias conditioned version of the second bitstream by applying a first whitening mask to the second bitstream, the applying the first whitening mask to the second bitstream bias conditioning the third bitstream by spreading out, in the third bitstream, a distribution of bits within the second bitstream having a first value and bits within the second bitstream having a second value;
wherein the generating the at least one random number based, at least in part, on the second bitstream comprises generating the at least one random number using the third bitstream.

3. The method of claim 2, further comprising:
generating the first whitening mask by multiplexing a second whitening mask and a new mask.

4. The method of claim 2, further comprising:
generating the first whitening mask by multiplexing a second whitening mask, a third whitening mask and a new mask, wherein the third whitening mask is generated by performing a circular shift on the second whitening mask.

5. The method of claim 1, further comprising:
generating a plurality of third bitstreams, each of the plurality of third bitstreams being a bias conditioned version of a respective one of the plurality of first bitstreams, by applying a first whitening mask to each of the plurality of first bitstreams, the applying the first whitening mask to each of the first bitstreams bias conditioning the plurality of third bitstreams by spreading out, in the plurality of third bitstreams, a distribution of bits within the plurality of first bitstreams having a first value and bits within the plurality of first bitstreams having a second value;
wherein the generating the plurality of samples by sampling each of the plurality of first bitstreams comprises generating the plurality of samples by sampling each of the plurality of third bitstreams, which are bias conditioned versions of the plurality of first bitstreams.

6. The method of claim 1, further comprising:
responsive to determining that random number generation is to be paused, deactivating the plurality of oscillators.

7. The method of claim 1, wherein the plurality of oscillators are ring oscillators that are spatially separated, physically, from one another by a minimum threshold distance, wherein the threshold distance is at least 500 μm.

8. A random number generator, comprising:
a plurality of oscillators; and
a hardware conditioner configured to receive a plurality of first bitstreams, each of the plurality of first bitstreams received from a respective one of the plurality of oscillators, generate a plurality of samples by sampling each of the plurality of first bitstreams, and generate a second bitstream by serially combining the plurality of samples, generate at least one random number based, at least in part, on the second bitstream;
wherein the random number generator outputs the at least one random number to a processor.

9. The random number generator of claim 8, wherein:
the hardware conditioner generates a third bitstream that is a bias conditioned version of the second bitstream by applying a first whitening mask to the second bitstream, the applying the first whitening mask to the second bitstream bias conditioning the third bitstream by spreading out, in the third bitstream, a distribution of bits within the second bitstream having a first value and bits within the second bitstream having a second value; and
the generating the at least one random number based, at least in part, on the second bitstream comprises generating the at least one random number using the third bitstream.

10. The random number generator of claim 9, the hardware conditioner comprising:
a mask updater configured to generate the first whitening mask by multiplexing a second whitening mask and a new mask.

11. The random number generator of claim 9, the hardware conditioner comprising:
a mask updater configured to generate the first whitening mask by multiplexing a second whitening mask, a third whitening mask and a new mask, wherein the third whitening mask is generated by performing a circular shift on the second whitening mask.

12. The random number generator of claim 8, wherein:
the hardware conditioner generates a plurality of third bitstreams, each of the plurality of third bitstreams being a bias conditioned version of a respective one of the plurality of first bitstreams, by applying a first whitening mask to each of the first bitstreams, the applying the first whitening mask to each of the plurality of first bitstreams bias conditioning the plurality of third bitstreams by spreading out, in the plurality of third bitstreams, a distribution of bits within the plurality of first bitstreams having a first value and bits within the plurality of first bitstreams having a second value; and
the hardware conditioner generates the plurality of samples by sampling each of the plurality of third bitstreams, which are bias conditioned versions of the plurality of first bitstreams.

13. The random number generator of claim 8, wherein the random number generator is configured to, responsive to determining that random number generation is to be paused, deactivate the plurality of oscillators.

14. The random number generator of claim 8, wherein the plurality of oscillators are ring oscillators that are spatially separated, physically, from one another by a minimum threshold distance, wherein the threshold distance is at least 500 μm.

15. A system, comprising:
a random number generator within, or communicatively linked to, a processor, the random number generator comprising:
a plurality of oscillators; and
a hardware conditioner configured to receive a plurality of first bitstreams, each of the plurality of first bitstreams received from a respective one of the plurality of oscillators, generate a plurality of samples by sampling each of the plurality of first bitstreams, generate a second bitstream by serially combining the plurality of samples, and generate at least one random number based, at least in part, on the second bitstream;
wherein the random number generator outputs the at least one random number to the processor.

16. The system of claim 15, wherein:
the hardware conditioner generates a third bitstream that is a bias conditioned version of the second bitstream by applying a first whitening mask to the second bitstream, the applying the first whitening mask to the second bitstream bias conditioning the third bitstream by spreading out, in the third bitstream, a distribution of bits within the second bitstream having a first value and bits within the second bitstream having a second value; and
the generating the at least one random number based, at least in part, on the second bitstream comprises generating the at least one random number using the third bitstream.

17. The system of claim 16, the hardware conditioner comprising:
a mask updater configured to generate the first whitening mask by multiplexing a second whitening mask and a new mask.

18. The system of claim 16, the hardware conditioner comprising:
a mask updater configured to generate the first whitening mask by multiplexing a second whitening mask, a third whitening mask and a new mask, wherein the third whitening mask is generated by performing a circular shift on the second whitening mask.

19. The system of claim 15, wherein:
the hardware conditioner generates a plurality of third bitstreams, each of plurality of third bitstreams being a bias conditioned version of a respective one of the plurality of first bitstreams, by applying a first whitening mask to each of the plurality of first bitstreams, the applying the first whitening mask to each of the first bitstreams bias conditioning the plurality of third bitstreams by spreading out, in the plurality of third bitstreams, a distribution of bits within the plurality of first bitstreams having a first value and bits within the plurality of first bitstreams having a second value; and
the hardware conditioner generates the plurality of samples by sampling each of the plurality of third bitstreams, which are bias conditioned versions of the plurality of first bitstreams.

20. The system of claim 15, wherein the random number generator is configured to, responsive to determining that random number generation is to be paused, deactivate the plurality of oscillators.
